(19) United States
(12) Patent Application Publication
(10) Pub. No.: US 2007/0074176 A1
(43) Pub. Date: Mar. 29, 2007

(54) Apparatus and method for parallel processing of data profiling information

(75) Inventors: Wu Cao, Redwood City, CA (US); Freda Xu, Cupertino, CA (US); Monfor Yee, San Francisco, CA (US)

Correspondence Address: COOLEY GODWARD KRONISH LLP, 3000 EL CAMINO REAL, 5 PALO ALTO SQUARE, PALO ALTO, CA, 94306, US

(73) Assignee: Business Objects, S.A., Levallois-Perret (FR)

(21) Appl. No.: 11/395,414

(22) Filed: Mar. 30, 2006

Related U.S. Application Data
(60) Provisional application No. 60/720,277, filed on Sep. 23, 2005.

(51) Int. Cl. G06F 9/44

(52) U.S. Cl. 717/130; 717/131

(57) ABSTRACT

A computer readable medium comprising executable instructions to process data in a data profiling system includes executable instructions to establish a plurality of attribute profiling threads, distribute columns of a selected row of a table across the plurality of attribute profiling threads, and generate data profiling information.

### CROSS REFERENCE TO RELATED APPLICATIONS

This application claims the benefit of U.S. Provisional Application No. 60/720,277, entitled “Apparatus and Method for Parallel Processing of Data Profiling Information,” filed on Sep. 23, 2005, the contents of which are hereby incorporated by reference in their entirety.

### BRIEF DESCRIPTION OF THE INVENTION

This invention relates generally to information processing. More particularly, this invention relates to parallel processing of data profiling information.

### BACKGROUND OF THE INVENTION

Database profiling is the process of analyzing a database to determine its structure and internal relationships. Database profiling assesses such issues as the tables used, their keys and number of rows, the columns used and the number of rows with a value, relationships between tables and columns copied or derived from other columns. Database profiling can also include analysis of tables and columns used by different applications, how tables and columns are populated and changed, and the importance of different tables and columns. Database profiling is useful when planning and managing data conversion and data cleanup projects. In addition, database profiling can be an initial step in defining a data quality domain, which is used in data quality profiling.

In some respects, database profiling is analogous to data processing operations performed on a database. Database profiling operations are also analogous to operations performed during the process of migrating data from a source (e.g., a database) to a target (e.g., another database, a data mart or a data warehouse), which is sometimes referred to as Extract, Transform and Load, or the acronym ETL. Unlike database and ETL operations, database profiling is potentially applied to multiple varied data sources and therefore requires different processing techniques. For example, data profiling systems may store metadata related to the data attributes being processed instead of actual data.

Current data profiling systems provide rudimentary forms of data processing and characterization. These tools fail to provide efficient data processing operations. Accordingly, it would be desirable to provide improved data profiling techniques that address data processing and characterization deficiencies associated with prior art approaches.

### SUMMARY OF THE INVENTION

The invention includes a computer readable medium comprising executable instructions to process data in a data profiling system. The executable instructions include executable instructions to establish a plurality of attribute profiling threads, distribute columns of a selected row of a table across the plurality of attribute profiling threads, and generate data profiling information.

The invention provides significant performance improvements. Data profiling operations commonly entail reading millions of rows from a source and then calculating the attributes of every column. The parallel processing of the invention enables the processing of columns in one row on different threads.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates inputs and outputs associated with an embodiment of the invention.

FIG. 3 illustrates processing of database table information across multiple threads in accordance with an embodiment of the invention.

FIG. 4 illustrates profile data formed in accordance with an embodiment of the invention.

FIG. 5 illustrates profile data that may be displayed to a user in accordance with an embodiment of the invention.

Like reference numerals refer to corresponding parts throughout the several views of the drawings.

### DETAILED DESCRIPTION OF THE INVENTION

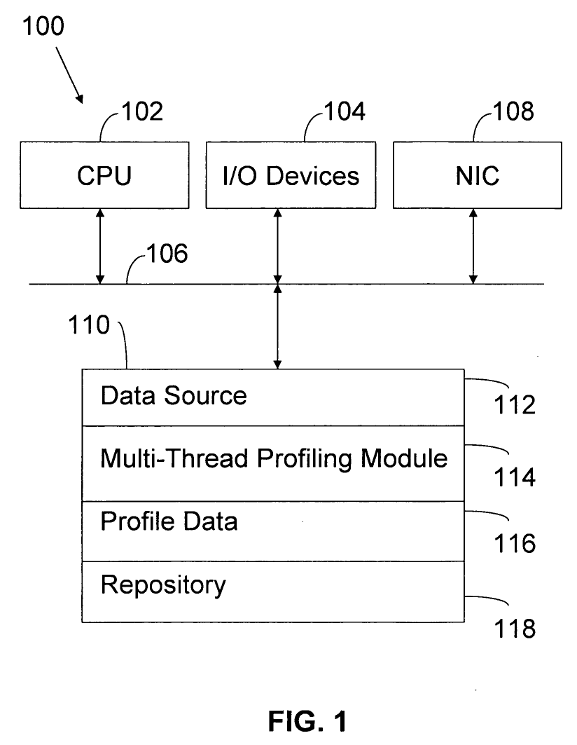

FIG. 1 illustrates a computer 100 configured in accordance with an embodiment of the invention. The computer 100 includes a central processing unit 102 connected to a set of input/output devices 104 via a bus 106. Multiple central processing units may be connected to the bus 106 to implement multi-threading operations of the invention.

The input/output devices 104 may include a keyboard, mouse, touch screen, display, printer and the like. A network interface circuit 108 is also connected to the bus 106. The network interface circuit 108 provides connectivity to a network (not shown). Thus, the invention may operate in a networked environment, such as a client/server environment or a peer-to-peer network where multi-threading operations of the invention are distributed across a number of processors.

A memory 110 is also connected to the bus 106. The memory 110 stores executable instructions to implement operations associated with the invention. The memory 110 may also store a data source (e.g., a database) 112. The data source stores data that is processed by a multi-thread profiling module 114. The multi-thread profiling module 114 includes executable instructions to implement multi-thread profiling processing operations of the invention.

A thread refers to a string of execution. Threads allow a computer program to split itself into two or more simultaneously running tasks. Multiple threads can be executed in parallel on a set of computers or on a single computer. Multi-threading generally occurs by time slicing (e.g., a single processor switches between different threads) or by multiprocessing (e.g., where threads are executed on separate processors). Many modern operating systems directly support both time-sliced and multiprocessor threading with a process scheduler. Operating system kernels commonly allow programmers to manipulate threads via a system call interface. Programs can implement threading by using timers, signals, or other methods to interrupt their own execution and perform ad hoc time-slicing.

Any number of multi-threading techniques may be used in accordance with the invention. In one embodiment of the invention, the multi-thread profiling module 114 includes executable instructions to establish a set of attribute profiling threads. The set of attribute profiling threads are configured as time sliced attribute profiling threads on a single processor. In another embodiment of the invention, the multi-thread profiling module 114 includes executable instructions to establish a set of attribute profiling threads on multiple processors. The multiple processors may be in a single machine or may be distributed across a network. In one embodiment of the invention, the multi-thread profiling module 114 includes executable instructions to establish a number of attribute profiling threads corresponding to the lower value between a minimum degree of available processing parallelism (either on a single machine or a set of machines) and the total number of columns to be processed.

The multi-thread profiling module 114 produces profile data 116, which may be stored in a repository 118. The data and executable modules of memory 110 may be distributed across a network. The operations of the invention are significant. Where those operations are performed on a computer or within a network is not significant, nor is the precise implementation of those operations significant.

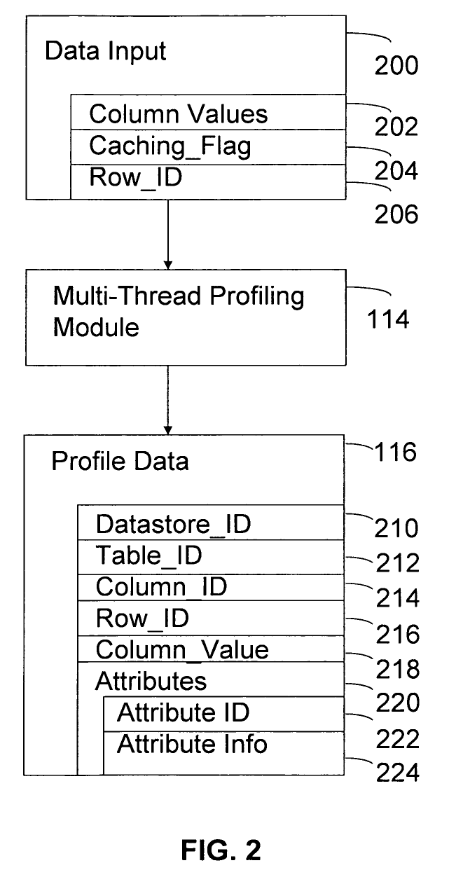

FIG. 2 illustrates exemplary input and output associated with an embodiment of the invention. Data input 200 is applied to the multi-thread profiling module 114. In one embodiment, the data input 200 includes column values 202. Metadata values may also form a portion of the data input. In one embodiment of the invention, metadata in the form of a cache flag 204 and row identification 206 is utilized. In this embodiment, the cache flag 204 is set when a row needs to be saved, for example, because it holds an exemplary value that will be reflected in the profile data 116. Similarly, the row identification 206 may be saved when the cache flag 204 is set so that information within the profile data 116 can be traced.

The multi-thread profiling module 114 generates profile data 116. In one embodiment, the profile data is normalized to a standard format. For example, the profile data 116 may be normalized to include a data store identification 210, a table identification 212, a column identification 214, a row identification 216, a column value 218 and attributes 220. For example, the attributes may include an attribute identification 222 and attribute information 224.

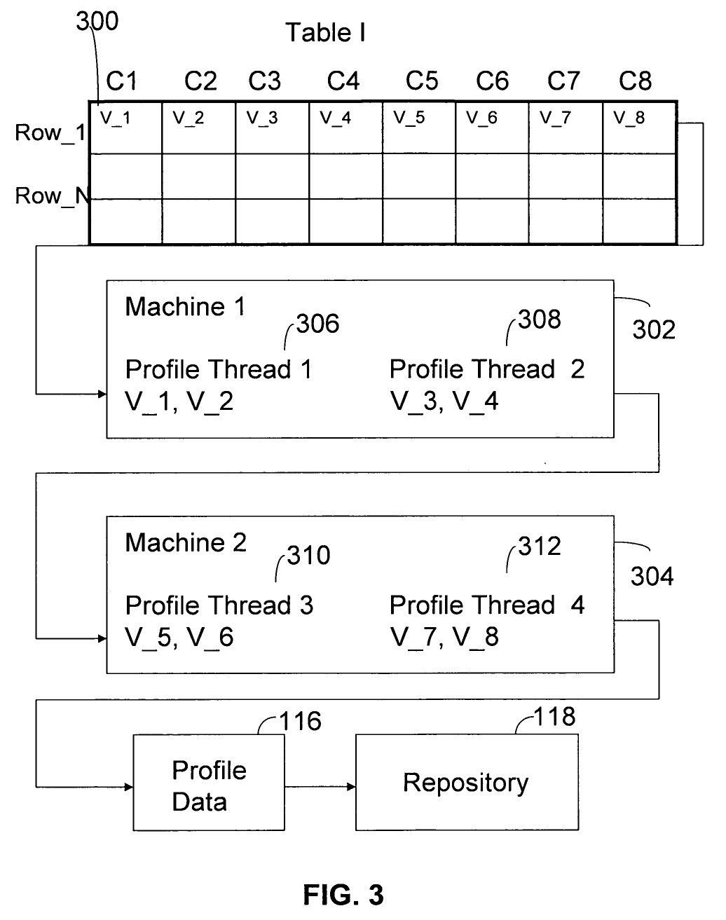

FIG. 3 illustrates a table 300 within a data source 112. The table 300 includes a set of rows Row_1 through Row_N and a set of columns C1 through C8. Row_1 has a set of values V_1 through V_8. That is, value V_1 is associated with the first column C1, value V_2 is associated with the second column C2, and so forth. The multi-thread profiling module 114 includes executable instructions to read a row of data. The row of data is then applied to a set of profile threads 306, 308, 310 and 312. As previously discussed, the multi-thread profiling module 114 establishes a set of profiling threads, either on a single processor or multiple processors. In the example of FIG. 3, a first machine 302 includes two profile threads 306 and 308. Profile thread 306 is assigned to process values from the first two columns, in this case, values V_1 and V_2. Profile thread 308 is assigned to process values from the third and fourth columns, in this case, values V_3 and V_4. The profile threads 306 and 308 may operate on a single processor of machine 302 or on multiple processors associated with the same machine.

The second machine 304 also includes two profile threads, namely, profile threads 310 and 312. Profile thread 310 is assigned to process threads from the fifth and sixth columns, in this case, values V_5 and V_6. Profile thread 312 is assigned to process threads from the seventh and eighth columns, namely values V_7 and V_8.

The multi-thread profiling module 114 configures each profile thread to track specified profiling information for the column that it processes, such as a low value, a high value, a low value count, a high value count, average value, median value, minimum string length, maximum string length, average string length, median string length, distinct count, distinct percent, null count, null percent, zero count, zero percent, blank count, blank percent, and the like. This processing results in profile data 116. The profiling data 116 may then be applied to a repository 118 using standard techniques.

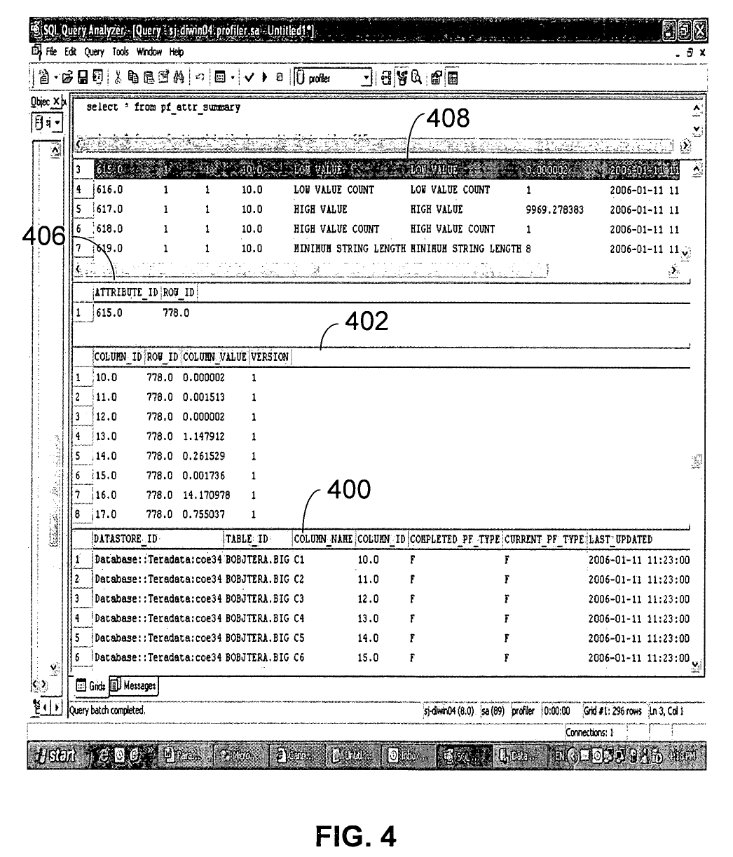

FIG. 4 illustrates profile data 116 formed in accordance with an embodiment of the invention. Graphical User Interface (GUI) block 400 includes information specifying a data store identification, a table identification, a column name, a column identification, etc. GUI block 402 includes information on a column identification, row identification, and a column value. Thus, the column identification information from GUI block 400 can be mapped to the information in GUI block 402. For example, the column identification value “10” of GUI block 400 can be mapped into GUI block 402. GUI block 402 illustrates that column identification “10” has a corresponding row identification of “778.0” and a column value of “0.000002”.

GUI block 406 allows the mapping of a row identification value to an attribute identification. For example, row identification value “778” from GUI block 402 maps to an attribute identification of “615.0” in GUI block 406. The attribute identification value allows mapping to attribute information. For example, GUI block 408 links the attribute identification “615.0” to the attribute information of “Low Value” for the given column. The attribute information also includes the specified value of “0.000002”, which is the column value shown in GUI block 402.

Naturally, any number of configurations may be used to display profile data 116. The configuration of FIG. 4 is simply an exemplary configuration. The linking of profile information to table information, as shown in FIG. 4, is typically performed using executable instructions associated with the multi-thread profiling module 114.

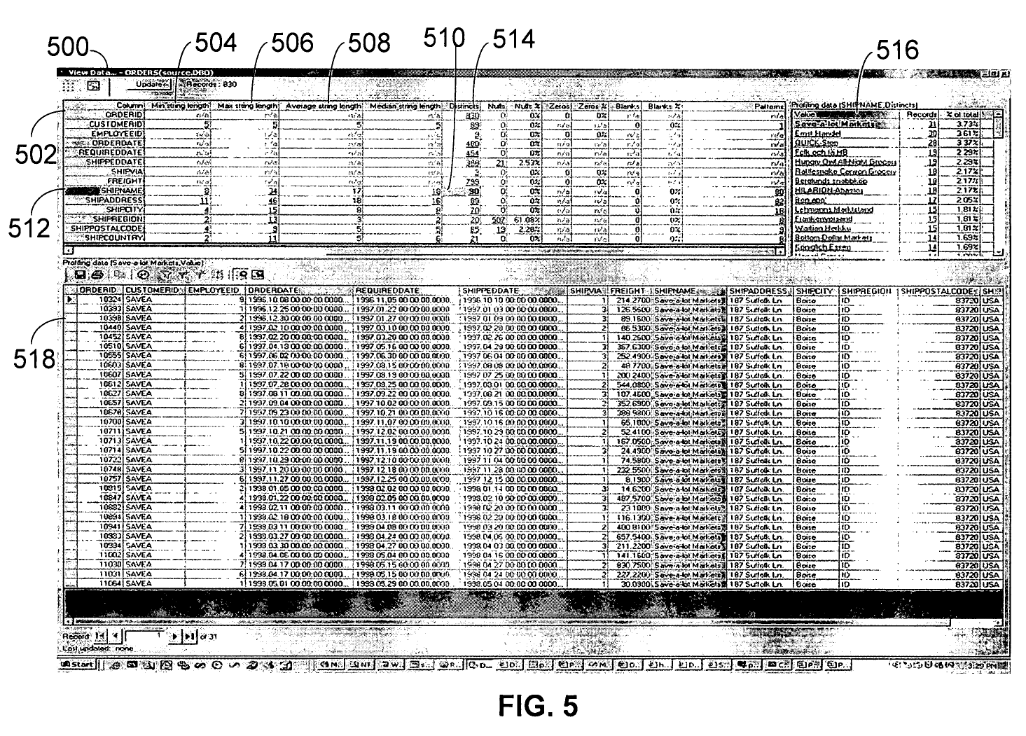

FIG. 5 illustrates a graphical user interface (GUI) 500 that may be used in accordance with an embodiment of the invention to display profiling data. The GUI 500 includes information on individual columns. For example row 502 includes information on the column “ORDERID”. In particular, the row 502 includes information on “ORDERID” profiling values, including minimum string length 504, maximum string length 506, average string length 508, etc.

The GUI 500 facilitates the drill down to source information. For example, cell 510 is at the intersection of the column value “SHIPNAME” or row 512 and the “Distincts” column 514. Information on this cell is provided in block 516. By clicking on the first entry of block 516, i.e., Save-a-lot Markets, the thirty-one records associated with this entity are displayed in block 518. Thus, an embodiment of the invention allows a user to drill down to data source information.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium storing executable instructions to process data in a data profiling system, comprising executable instructions to:
establish a plurality of attribute profiling threads;
distribute columns of a selected row of a table across the plurality of attribute profiling threads; and
generate data profiling information.

2. The computer readable medium of claim 1 further comprising executable instructions to add metadata to the columns of the selected row.

3. The computer readable medium of claim 2 wherein the executable instructions to add metadata include executable instructions to add a cache flag.

4. The computer readable medium of claim 3 further comprising executable instructions to set the cache flag when a row needs to be saved.

5. The computer readable medium of claim 2 wherein the executable instructions to add metadata include executable instructions to add a row identification.

6. The computer readable medium of claim 5 further comprising executable instructions to record the row identification when a cache flag is set.

7. The computer readable medium of claim 1 wherein the executable instructions to establish a plurality of attribute profiling threads include executable instructions to establish a number of attribute profiling threads corresponding to the lower value between a minimum degree of available processing parallelism and the total number of columns to be processed.

8. The computer readable medium of claim 1 wherein the executable instructions to generate data profiling information include executable instructions to normalize the data profiling information in a standard format.

9. The computer readable medium of claim 8 wherein the executable instructions to normalize the data profiling information in a standard format include executable instructions to specify a data store identification, a table identification, a column identification, a row identification, a column value, and attribute information.

10. The computer readable medium of claim 1 wherein the executable instructions to establish a plurality of attribute profiling threads include executable instructions to time slice attribute profiling threads on a single processor.

11. The computer readable medium of claim 1 wherein the executable instructions to establish a plurality of attribute profiling threads include executable instructions to process the attribute profiling threads on multiple processors.

12. The computer readable medium of claim 1 further comprising executable instructions to display the data profiling information.

13. The computer readable medium of claim 12 further comprising executable instructions to facilitate the display of source information from the data profiling information.
